(19) United States
(12) Patent Application Publication
(10) Pub. No.: US 2018/0158149 A1
(43) Pub. Date: Jun. 7, 2018

(54) Sports social network, scheduling and meetup system

(71) Applicant: Rhonda Straub, Winter Garden, FL (US)

(72) Inventor: Rhonda Straub, Winter Garden, FL (US)

(21) Appl. No.: 15/368,595

(22) Filed: Dec. 3, 2016

(51) Int. Cl. G06Q 50/00; G06Q 10/10

(52) U.S. Cl. CPC G06Q 50/01; G06Q 10/1095

(57) ABSTRACT

The current invention is a social network and meetup app for people who like recreational sports like golf. It is GPS-centric. The system will allow the user to: search for other players using 3 GPS-driven search options: search by a screen name; have a search-and-Link function which functions with a left swipe/right swipe function; list a view of players in a search radius with a link request. The system enables users to create and publish tee time invitations to the user population or subsets of the user population and receive responses from the user population. The system enables users with membership at members-only courses and clubs to connect and host one another as guests.

### CROSS-REFERENCES TO RELATED APPLICATIONS (IF ANY)

None.

### BACKGROUND

### 1. Field of the Invention

The field of the invention is a method and system for a sports social network, scheduling and meetup system, specifically applications that matches people for group play and locations

### 2. Description of Prior Art

Recreational sports like golf and tennis are very big in the United States and the world. It can be relaxing and good exercise. But sometimes it is difficult to find someone to golf or play with especially if you are traveling or new to an area.

Also, many people are members of a particular golf course or tennis club but they would like to try new courses or clubs but don't have a good way to do it.

There is still room for improvement in the art.

### SUMMARY OF THE INVENTION

The current invention is a social network and meetup app for people who like recreational sports like golf. It is GPS-centric. The mobile app has a corresponding web portal for paid features. The description will describe the system working with golf but can be used for any sport.

The system will allow user to search for other golfers using 3 GPS-driven search options based on their physical location or a desired location: search for a person by screen name; have a search-and-Link function which functions with a left swipe/right swipe function; list a view of golfers in a search radius and connect via a link request.

The system will have a chat function as well as a newsfeed view/post/comment/share function.

It will allow users to create Tee Time Invitations to which other users can respond, and create events.

It will allow a golfer to search golf courses in their area based on their location or a desired location.

The system will allow golfers with membership at members-only courses and/or clubs to connect and host one another as guests.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 is a flow chart of one embodiment of the present invention for user input of data;

FIG. 2 is a screen shot of the login screen;

FIG. 3 is a screen shot of the login screen; and

FIG. 4 is a screen shot of the radar search result screen

### DESCRIPTION OF THE PREFERRED EMBODIMENT

There are a number of significant design features and improvements incorporated within the invention.

The present invention is for a computer-based system for the current invention is a social network and meetup app for people who like recreational sports like golf. It is GPS-centric. The mobile app has a corresponding web portal for paid features. The description will describe the system working with golf but can be used for any sport or gaming event.

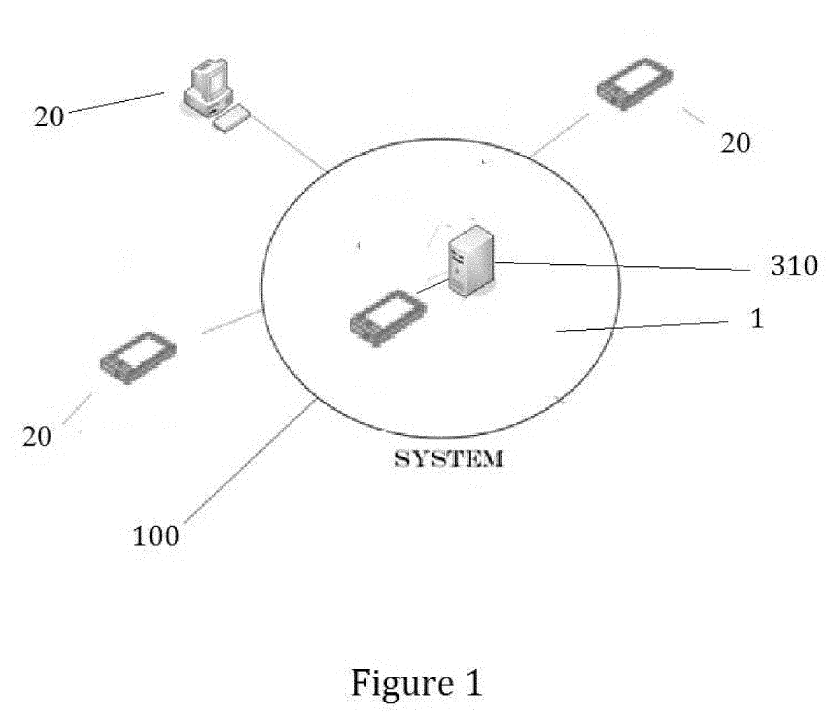

FIG. 1 displays the preferred embodiment of the system architecture accessed through an Internet, Intranet and/or Wireless network 500. However, the system could be implemented on a device-to-device or client/server architecture as well.

In FIG. 1, the system is accessed from a user's computing device 10 through a web browser over HTTP and/or HTTPS protocols 500 or wireless network or cell phone to cell phone connection. A computing device 20, such as a smart phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet 500. Computing devices like this are well known in the art and are not pertinent to the invention. The computing devices 20 can serve as an input/output (I/O) device for inputting an original writing and video from a user and for outputting a modified writing and video.

The system 1, data and processing code can reside in the non-transitory memory 310 of one or more computing devices. The system 1 in the preferred embodiment would be written to act like a smart phone application (app) where the different apps can communicate with each. The system 1 may work with a central server as shown in FIG. 1 or in parallel which each computing device 10 or smartphone communicating with others within the system 1.

The system 1, data and processing code can reside in the non-transitory memory 310 of the one or more computing devices. The system 1 in the preferred embodiment would be written to act like a smart phone application (app).

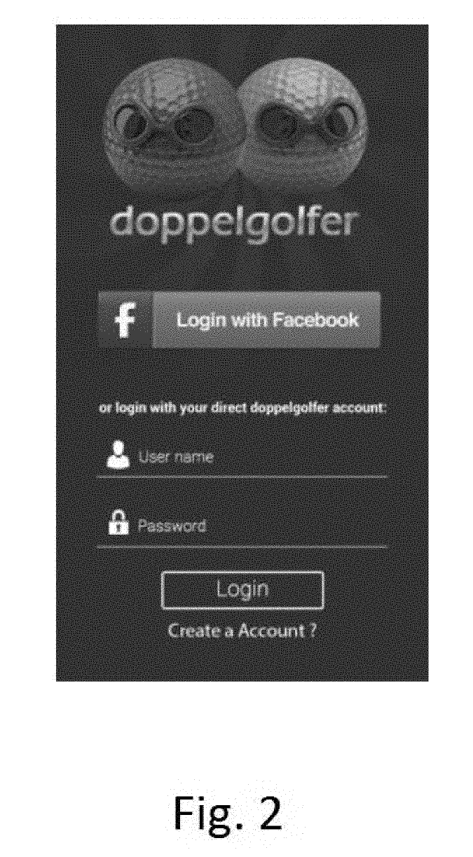

The users would sign-in directly or using social logins as shown in FIG. 2 with the user registering the app

If logging in from a social media site the initial login will only require First Name, Last Name, screen name, email address, gender. The rest of the login can be auto-populated from the social media site. Once logged in users are directed to create their full profile. Users can create a direct account without using a social media site.

In one embodiment of the inventive system, a user would first register with the system and set up a user profile, to include but not limited to name, gender, date of birth, location, and other relevant information, related to the specific use of that application.

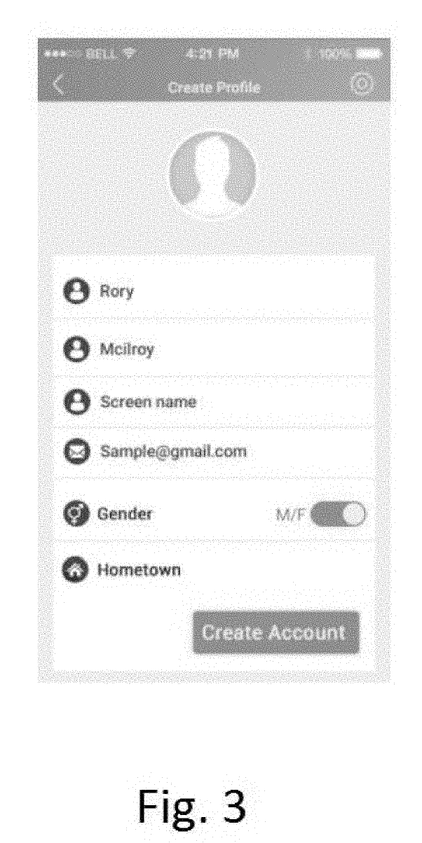

After an account is created, users will be instructed to create their Full Profile as shown in FIG. 3. After the initial creation of the user profile, the ‘My Profile’ option on the main menu will go to “Review/Edit”. In the preferred embodiment there would be mandatory profile fields that must be populated in order for a profile to be created. These fields are: First Name, (initial account creation), Last Name, (initial account creation), Email, (initial account creation), Screen Name, (initial account creation), age, gender, (initial account creation), skill level, instructor if the user is one, whether or not they are a single player, and children who play (age 13 or under), designate a home course and/or club.

The system 1 will allow the User to provide a profile photo. The system 1 will allow the user to edit or remove or replace this photo after it has been uploaded.

The user can review and edit their profile as needed or desired.

With the system 1 a user can search for other golfers using 3 GPS-driven search options. This search can be done by screen name if the person is already known and wants to be connected within the app. The user can use a search-and-link which gives the user a random selection to choose from and allows the user to choose using a choosing means like a left swipe accept, right swipe don't function.

The system 1 would give the user a list view where it displays golfers within a set search radius, and an option to send a ‘link’ request. The recipient has the option to accept or decline the link request. Once ‘linked’, communications between the users are enabled so they can set up a golf match. Golfers can ‘unlink’ from other users easily at their discretion. This disables communication options and deletes prior communication records.

The system 1 would have a chat function that would allow users to communicate with each other as well as a newsfeed view/post/comment/share function. It would allow the user to create tee time invitations or events.

The system 1 would allow the user to search for golf course in their area. This would be based on the system's ‘Search Settings.’ These profiles display detailed information about golf courses in the area who have published their Course Profiles directly with system 1. Search results are based on the GPS position of the user and the search criteria in the user's settings. Golf course profiles showcase unique features of the course. Course profile mandatory information includes: Location, Public or Private course, Price, Par, Yardage and USGA rating, partner hotels.

With the system 1, the golf courses will publish their open (ie: last minute) tee times available at discounted prices. Golfers can search available published tee times, select a tee time, and book it at the published price directly through the system 1. Golfers can optionally include another golfer—to whom they are linked—in the tee time booking. In the preferred embodiment, the course profiles also provide: a Calendar of Events; driving directions from the user's current GPS location to the golf course; option to contact (direct dial) the golf course for a tee time booking; and any partner hotel information including special prices offered to the system's users and an option to contact (direct dial) the hotel for a booking.

These are paid publications. Golf courses will pay a monthly subscription that enables publishing and booking of open tee times, course profile details (events, etc), and partner hotel details and special rates. Because these are paid features, this activity will occur via the web portal: payments can be processed then golf courses and/or hotels can create and update their profile information.

The system 1 would have a “subscribe” button function that would enable auto-post of any new content on the golf course profile page to the user's Newsfeed.

The system 1 has a ‘Near Me’ option that searches a database or executes an internet search for “golf courses near me” with a map display.

The users can use the system 1 to Search Tee Time Invitations. Invitations are created by other golfers. Users can create a Tee Time Invitation and publish it to the community. Other users can respond, and the user who posted the invitation can ‘accept’ or ‘decline’ the responses.

The system would have a view and interact via the Newsfeed where Users can post texts, videos, photos, and web links. The posts of ‘linked’ golfers are visible within the newsfeed with the ability to respond/comment.

The system 1 will allow users to view and manage their list of other golfers that they are linked to via a manage link function. This function displays all of the golfers to whom a user is currently linked. Once two or more users are ‘linked’, industry-standard Chat communications are enabled as well as being able to post and view notifications.

A Mutual match notification via the ‘Search and Match’ feature when selected will display the other golfer's profile with an option to chat. This notification is generated only when 2 users both swipe ‘accept’ on one another's profile via the ‘Search and Match’ feature. The users can send link requests directly from one golfer to another. Selecting this notification will display the sender's profile with an option to ‘accept’ or ‘decline’ the link request.

The system 1 will provide Tee Time booking confirmations. This notification will display the tee time details (who, where, when, etc.). The system 1 can also send out Tee Time invites. Selecting this notification will display details of the invitation with an option to respond to the invites. Selecting this notification will display details about the invitation/event (who, what, where, when) with an option to ‘attend’.

The system 1 will have a functionality to allow the users to Trade A Round where golfers with a paid club membership can trade hosting one another at their respective clubs. In this way a golfer's club ownership now grants them play at other exclusive, likely members-only clubs, they could otherwise not access or would have to pay to play.

For this function the golfer creates a “Trade Listing” about his/her current club membership. This listing contains the link to the full profile of the golfer who created the listing (the Host) and a link to the Golf Course Profile of the golfer's designated “Home Course” from their Golfer Profile. This will populate the Name, Address, and other details of the golf course. If there is no Golf Course Profile in the system yet for the designated course, then the trade listing will require: the Club/course name, address, link to website, images, brief description.

The system 1 will provide a calendar where the Host can optionally designate date(s) when available to host a guest. There will be a listing status as Active or Inactive which determines visibility in searches. Other golfers can view the listing and respond if they are interested in completing a trade. The trade host can view the message content with a link to the responder's Profile to determine if a trade is desirable and respond. If the golfer who created the trade listing (the host) wants to accept another golfer as the trade guest, they click “Accept” in the response review screen. A trade is now “Accepted” and creates an active Trade Record in Trade History. An “Accepted” trade record is now visible in each golfer's Trade History screen. From this screen the golfers can message one another and submit status changes:

a. “Accepted”=the host has accepted a guest's trade response/request.

b. “Scheduled”=a date has been agreed upon by both parties and/or a tee time is booked.

c. “Complete”=Both parties must submit this status change in order for the status to be updated.

d. There is also an option to “cancel” a trade initiated by the host.

The system 1 will use a GPS search as a location option for golfers, tee time invitations and events or use the GPS coordinates of the computing device 20. The user can also put in a location or address as a location option. This feature is for users who will be traveling and want to find golfers in the destination area they will be visiting.

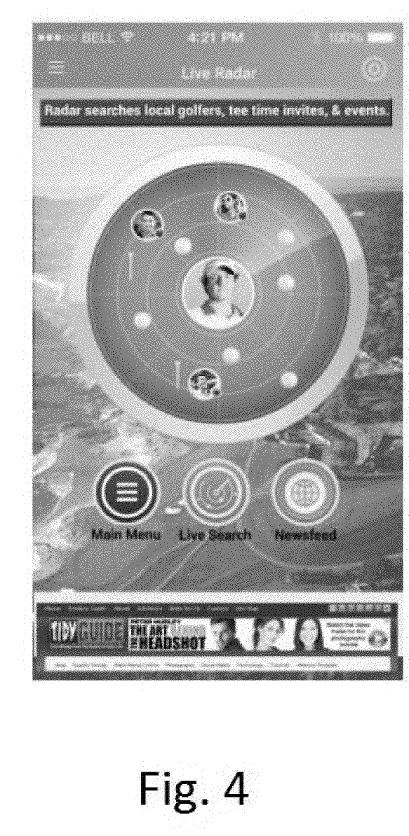

In the preferred embodiment, as shown in FIG. 4, the searches will be represented by an animated Radar Scanner where the screen returns a map that plots: Golfers, Events and Tee Time Invitations. The system 1 will use an icon which displays details: tee time invite, event, golfer profile. The system 1 will display the current user's photo in the center of the radar with other golfers, courses or events as symbols which are positioned in approximate position on the screen to match the location and distance they are from the current user.

When a user creates a new Tee Time invite it is based on date/time, golf course where the tee time is scheduled and the Number of open spots.

The system 1 will have Golf Courses create their profiles via the web portal. Course profile mandatory Overview information can include whether it is a Public or Private course, location and distance away from the user's current location or inputted address, the price, par and Yardage, partner hotels.

Selecting the ‘List View’ button from the map displays the course profiles in list format. Default search result display=distance away then price. The system includes a menu function at the top of this screen for ‘Sort Options’ such as distance away, Private/Semi-Private/Public and Price.

The user can book a Tee Time from published, discounted tee times from the course list or click a web link to book a tee time directly with the golf course.

Selecting the ‘Book Now’ button the system 1 will send a reservation notice to the golf course, with the golfer's name and email address, and will remove the open timeslot from the published tee times if the number of open player slots is reduced to 0.

GPS directions to this course from the user's current location is provided.

The system 1 will have the following revenue sources in the preferred embodiment. It will have advertisement bars appearing throughout the app. The Newsfeed feature can include paid advertisements. It can have paid monthly subscriptions by golf courses to a) publish their profile, b) publish and book discount tee times, c) publish partner hotel offers. The system 1 can charge for the initial download of the app as well as charging for activation of certain features such as the Trade A Round.

The system 1 allows the user to deactivate or delete their profile.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
having information about a player;
providing information to said player; and
allowing the player to set up an event.

2. A system according to claim 1 having said information is a list of other players.

3. A system according to claim 1 having said information is a list of golf courses.

4. A system according to claim 1 having a player log on to the system.

5. A system according to claim 4 having a player set up a profile.

6. A system according to claim 5 having the profile have one or more of the following information: name, skill level, instructor, age and gender, relationship status, home course.

7. A system according to claim 5 having the user profile a photo.

8. A system according to claim 1 having a GPS search means.

9. A system according to claim 1 having a GPS search means.

10. A system according to claim 1 having a search and link function.

11. A system according to claim 9 displaying players within a set search radius.

12. A system according to claim 11 having a link function between players.

13. A system according to claim 12 allowing a player to reject a link request.

14. A system according to claim 9 displaying golf courses with a set search radius.

15. A system according to claim 14 displaying the tee times at the golf course.

16. A system according to claim 14 having a player select a tee time at the golf course.

17. A system according to claim 1 allowing a player to trade courses.

18. A system according to claim 17 having the player create a trade listing of the course that the player wants to trade.

19. A system according to claim 19 having another player creates a trade listing of the course that the other player wants to trade and the player either accepts, schedules, completes or cancels the trade.

20. A system comprising;
having a system that resides in the non-transitory memory of a computing device;
having information about a player;
providing information to said player;
allowing a player to trade courses;
having the player create a trade listing of the course that the player wants to trade;
having another player creates a trade listing of the course that the other player wants to trade and the player either accepts, schedules, completes or cancels the trade.
